(19) United States
(12) Patent Application Publication
(10) Pub. No.: US 2025/0208325 A1
(43) Pub. Date: Jun. 26, 2025

(54) PHASE CHANGE MIRRORS

(71) Applicant: Teledyne Scientific & Imaging, LLC, Thousand Oaks, CA (US)

(72) Inventors: Sergio L. dos Santos e Lucato, Thousand Oaks, CA (US); Janet Davis, Thousand Oaks, CA (US)

(21) Appl. No.: 18/977,073

(22) Filed: Dec. 11, 2024

Related U.S. Application Data
(60) Provisional application No. 63/612,459, filed on Dec. 20, 2023.

(51) Int. Cl. G02B 5/10; G02B 5/08; H05B 3/00

(52) U.S. Cl. CPC G02B 5/10; G02B 5/0808; H05B 3/0004

(57) ABSTRACT

A method of forming a mirror comprises locating a phase change material in a baseplate, heating the phase change material, forming the phase change material in a liquid phase into a pre-determined shape, and cooling the phase change material until it reaches a solid phase.

### PRIORITY

The present application claims priority under 35 U.S.C. Section 119(e) from Provisional Application 63/612,459, entitled “PHASE CHANGE MIRRORS,” filed on Dec. 20, 2023, the entire contents of which is incorporated herein by reference.

### FIELD

This disclosure relates generally to the field of mirrors.

### SUMMARY

In part, in one aspect, the disclosure relates to a method of forming a mirror. The method comprises locating a phase change material in a baseplate, heating the phase change material, forming the phase change material in a liquid phase into a pre-determined shape, and cooling the phase change material until it reaches a solid phase.

In part, in one aspect, the disclosure relates to a phase change mirror made by a process comprising locating a phase change material in a baseplate, heating the phase change material, forming the phase change material in a liquid phase into a pre-determined shape, and cooling the phase change material until it reaches a solid phase.

Although, the disclosure relates to different aspects and embodiments, it is understood that the different aspects and embodiments disclosed herein can be integrated, combined, or used together as a combination system, or in part, as separate components, devices, and systems, as appropriate. Thus, each embodiment disclosed herein can be incorporated in each of the aspects to varying degrees as appropriate for a given implementation. These and other features of the applicant's teachings are set forth herein.

### BRIEF DESCRIPTION OF THE FIGURES

Unless specified otherwise, the accompanying drawings illustrate aspects of the innovations described herein. Referring to the drawings, wherein like numerals refer to like parts throughout the several views and this specification, several embodiments of presently disclosed principles are illustrated by way of example, and not by way of limitation. The drawings are not intended to be to scale. A more complete understanding of the disclosure may be realized by reference to the accompanying drawings in which:

FIG. 1 is a phase change mirror with a magnetic coil, according to an aspect of this disclosure.

FIG. 2 is a graphical depiction of the method of forming the phase change mirror of FIG. 1, according to an aspect of this disclosure.

FIG. 3 is a method of forming the phase change mirror of FIG. 1, according to an aspect of this disclosure.

FIG. 4 is a cross-sectional view of a phase change mirror, according to an aspect of this disclosure.

FIG. 5 is a cross-sectional view of a phase change mirror with coolant channels, according to an aspect of this disclosure.

FIG. 6 is a phase change mirror coupled to a motor, according to an aspect of this disclosure.

FIG. 7 is a graphical depiction of the method of forming the phase change mirror of FIG. 6, according to an aspect of this disclosure.

FIG. 8 is a method of forming the phase change mirror of FIG. 6, according to an aspect of this disclosure.

FIG. 9 is a system to heat an electrically conductive heating coil, according to an aspect of this disclosure.

FIG. 10 is a system to heat a baseplate, according to an aspect of this disclosure.

FIG. 11 is a coolant system, according to an aspect of this disclosure.

FIG. 12 is a system comprising a heating and cooling system, according to an aspect of this disclosure.

### DETAILED DESCRIPTION

This disclosure relates generally to low cost, large-scale mirrors based on phase-change materials (PCMs). The optical quality mirror surface is shaped as a liquid which is then solidified to enable operation in off-zenith conditions using mechanical manipulation systems like those of conventional telescopes. The solidification process is reversible through application of heat which allows the mirror to be repeatedly reshaped as needed for self-repair or reconfiguration for optical performance.

This phase change mirror has a lower cost than conventional astronomy telescope mirrors that use polished glass. The phase change mirror of this disclosure can operate in off-zenith conditions unlike liquid mirrors. The phase change mirror is also self-healing and damage tolerant as it can reform when damaged. The reforming time is faster than the time to form a rigid mirror as the phase change mirror can be re-formed in hours. The phase change mirror also has a larger imaging field than a liquid mirror and is scalable to large sizes (at least 10 m) without segmentation. The phase change mirror can use different materials that can be tailored to the use environment. For example, the material can be tailored to environments with gravity, microgravity, or no gravity.

The ability to form the mirror surface from a reflective liquid addresses the need for cost reduction for large optical systems. The ability to solidify the phase change mirror for use enables meeting the tip, tilt, and slew requirements unobtainable with conventional liquid mirrors which are limited to zenith orientation. The phase change mirror solves the zenith problem for state-of-the-art terrestrial liquid mirror systems in a facile manner by solidifying the mirror after forming the desired parabolic shape by rotation/magnetic field. Alternatively, for space-based telescopes, the mirror surface could also be formed by vehicle thrust.

In one aspect, for land-based, space and lunar systems, the mirror surface can be formed by the incorporation of ferromagnetic particles dispersed in a PCM matrix which becomes liquid at temperatures just above those of the service environment so that little energy is expended when heating the mirror reservoir. Once the matrix is liquefied, the magnetic field is applied to manipulate the particles vertically and laterally to shape the mirror surface. The heat and magnetic fields can be removed after solidification of the phase change mirror to save power. If the mirror surface is damaged, the phase change mirror is able to self-heal by re-melting and shaping.

For example, these phase change mirrors can be used in astronomy telescopes such as small-sized (0.5-2 m) telescopes for hobby astronomy applications (Celestron, etc.), or mid-sized (>2 m) telescopes for low-end professional astronomy applications (mobile observations), tracking telescopes, and satellite based telescopes.

In general, the disclosure is related to the use of a reflective material that will be liquefied by heating the material and then forming the mirror shape by use of a magnetic field or rotation. Once the mirror is formed, the reflective material will be solidified. The mirror is then a conventional solid mirror. In one aspect, the reflective material is further functionalized by dispersing a magnetic substance so that the mirror can be shaped through a magnetic field. The field is generated by permanent magnets or electromagnetic coils embedded in the base plate. The base plate contains the fluid.

In general, the baseplate contains the mirror material and the heating systems. In one aspect, the baseplate contains a magnetic system. In one aspect, the baseplate contains a cooling system. In general, heating and/or cooling is accomplished by passing a fluid through piping, electrical heating, or inductive heating.

In general, the mirror is formed by heating the mirror material above the melting point of the material. Then, a force is applied to the material. In one aspect, the force is a centrifugal force created by rotating the baseplate. In one aspect, the force is a magnetic field. Once the mirror is formed, the mirror material is cooled to the solid phase of the material. The mirror can repeat the process and reform. The mirror can reform to change the shape of the mirror or repair the mirror.

The mirror material is reflective. In one aspect, the mirror material is an inherently reflective material such as metal. In another aspect, the mirror material is reflective due to dispersing reflective particles in the material.

In one aspect, the magnetic system can either be permanent magnets or conductive coils to carry a DC current. Magnetic particles are dispersed in the mirror material. In one aspect, the electric coils for shaping the magnetic field can also be used to create inductive heating by passing an AC current. The current switches to DC once the mirror is liquid.

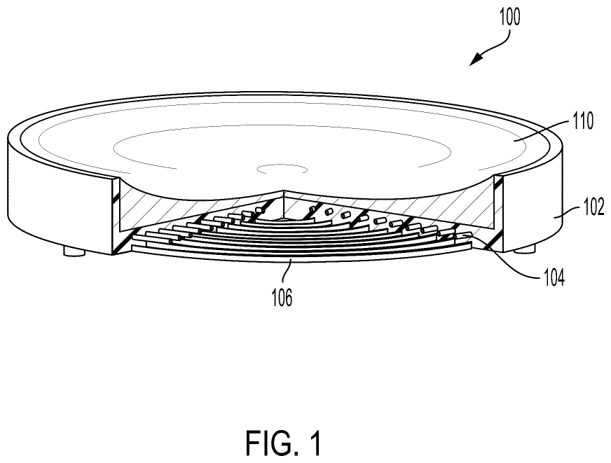

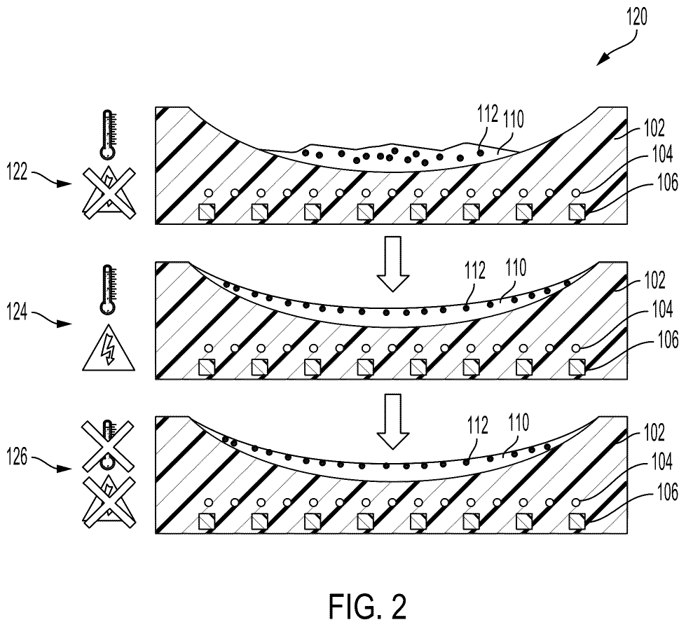

Turning now to the Figures, FIG. 1 is a phase change mirror 100 with a magnetic coil 106, according to an aspect of the disclosure. The phase change mirror 100 comprises a baseplate 102 structured to house the phase change material (mirror material) 110. The baseplate 102 defines a cavity and the phase change material 110 is located in the cavity of the baseplate 102. In one aspect, the bottom portion of the baseplate 102 defines a flat surface of the cavity (shown in FIG. 1). In one aspect, the bottom portion of the baseplate 102 defines an arcuate surface of the cavity such that the baseplate 102 defines a concave surface (shown in FIG. 2).

The bottom portion of the baseplate 102 defines cavities to house coils or tubes used for heating and/or applying a magnetic field. The coils or tubes are disposed within the baseplate 102. In one aspect, the baseplate 102 comprises a heating coil 104 and a magnetic coil 106. The baseplate 102 is thermally conductive to transfer heat from the heating coil 104 to the phase change material 110.

The phase change material 110 is disposed in the cavity of the baseplate 102. In one aspect, the phase change material 110 is a material with a melting/solidification temperature which exceeds the maximum intended use temperature of the mirror. In one aspect, the use temperature of the mirror is based on the temperature of the environment in which the phase change mirror 100 is to be used. The phase change material 110 changes between the solid and liquid phase based on the application of heat from the heating coils 104. Materials classes may include reflective metal alloys or polymeric composites containing reflective particles. Examples of materials are tin based solder alloys, Bismuth based fusible alloys, pure metals such as Mercury or Gallium or polymers such as paraffin. In one aspect, the phase change material 110 has ferromagnetic particles of Iron, Cobalt, or Nickel. In one aspect, the phase change material 110 has reflective particles dispersed within the phase change material 110.

In one aspect, the magnetic coil 106 is a permanent magnet disposed in the baseplate 102. The permanent magnet generates a continuous magnetic field. In another aspect, the magnetic coil is a conductive coil. A DC current is passed through the conductive coil to generate a magnetic field. The conductive coil is made of any conductive metal.

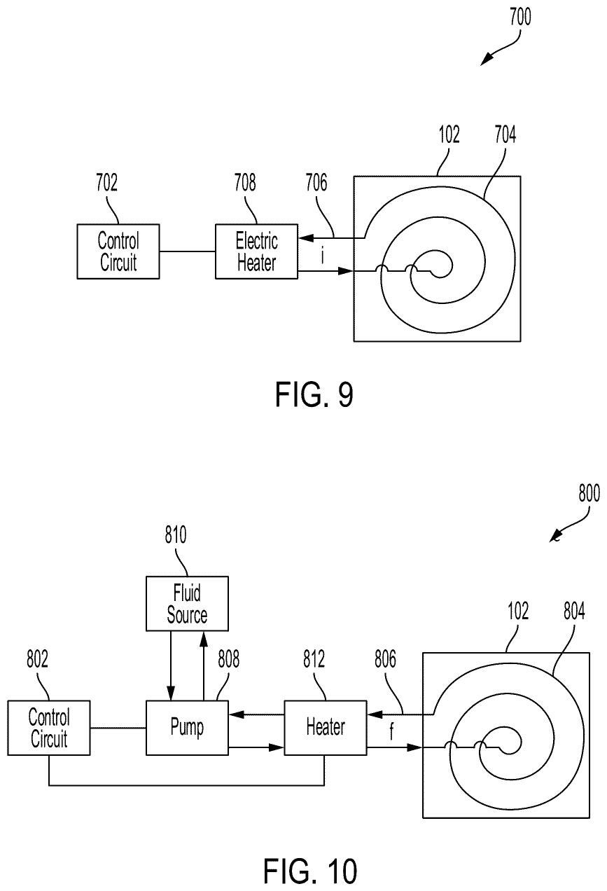

In one aspect, the heating coil 104 is an electrically conductive heating coil 704. Turning briefly also to FIG. 9, there is shown a system 700 comprising a control circuit 702 coupled to an electric heater 708 to heat an electrically conductive heating coil 704. The electrically conductive heating coil 704 is disposed within the bottom portion of the baseplate 102. The electrically conductive heating coil 704 receives an alternating or direct electric current (AC or DC) current 706 from the electric heater 708 that is controlled by the control circuit 702. In one aspect, the control circuit 702 is configured to control the application of heat by turning on and off the electric heater 708. The control circuit 702 is configured to control the application of current 706 from the electric heater 708 to the heating coil 704. In one aspect, the control circuit 702 is configured to control the temperature of the heater 708. In one aspect, the control circuit 702 is configured to control the temperature of the heater based on the temperature measured by the temperature sensor (not shown) disposed on the baseplate 102. The temperature of the heater 708 controls the temperature applied to the electrically conductive heating coil 704. The current 706 heats the electrically conductive heating coil 704 which transfers heat to the baseplate 102. The baseplate 102, being thermally conductive, transfers the heat to the phase change material 110.

In another aspect, the heating coil 104 is a tube 804 configured to receive a fluid. Turning briefly also to FIG. 10, there is shown a system 800 comprising a control circuit 802 coupled to a pump 808 in fluid communication with a fluid source 810. The pump 808 supplies the fluid 806 to a heater 812. The heated fluid 806 is received in the tube 804. The fluid 806 is heated by the heater 812 before entering the tube 804. The heat from the fluid 806 is transferred through the thermally conductive baseplate 102 to the phase change material 110. The control circuit 802 is configured to control the application of fluid 806 to the tube 804. For example, the control circuit 802 is configured to control the pump 808. The control circuit 802 is configured to turn on and off the pump 808. The pump 808 is configured to circulate fluid 806 from the fluid source 810 through the pump 808 to the heater 812, through the tube 804, back through the heater 812, through the pump 808, and into the fluid source 810. The control circuit 802 is configured to control the heater such that the control circuit is configured to control turning on and off the heater 812. In one aspect, the control circuit 802 is configured to control the temperature of the heater. The temperature of the heater controls the temperature of the fluid 806 applied to the tube 804. In one aspect, the control circuit 802 is configured to control the temperature of the heater based on the temperature measured by the temperature sensor (not shown) disposed on the baseplate.

In one aspect, the phase change mirror 100 is made by a process comprising locating a phase change material 110 in a baseplate 102, heating the phase change material 110, forming the phase change material 110 in a liquid phase into a pre-determined shape, and cooling the phase change material 110 until it reaches a solid phase.

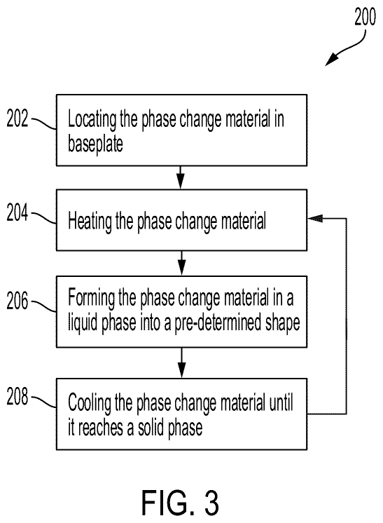

FIG. 2 is a graphical depiction 120 of the method of forming the phase change mirror 100 of FIG. 1, according to an aspect of this disclosure. FIG. 3 is a method 200 of forming the phase change mirror 100 of FIG. 1. FIGS. 2 and 3 are described in conjunction. The method 200 of forming the phase change mirror 100 comprises locating 202 the phase change material 110 in the baseplate 102. The method 200 of operating the phase change mirror 100 is controlled by a control circuit (not shown) coupled to the phase change mirror 100.

In one aspect, the method 200 further comprises dispersing a magnetic substance 112 in the phase change material 110 located in the baseplate 102. In one aspect, the magnetic substance 112 is homogenously disbursed through the phase change material 110. The magnetic substance 112 is homogenously disbursed by the magnetic field from the magnetic coil 106.

The method 200 further comprises heating 204 the phase change material 110. The phase change material 110 is heated above the melting point of the phase change material 110. By heating the phase change material 110 above the melting point, the phase change material 110 becomes a liquid. The liquid form of the phase change material 110 allows for the reformation of the phase change material 110 into a shape.

For example, heating 204 the phase change material 110 is shown in FIG. 2 by step 122. The phase change material 110 is shown before the magnetic field is applied. Heat is being applied through the heating coils 104. The magnetic field can be applied concurrently with the heat or subsequent to the phase change material 110 becomes liquid.

In one aspect, heating 204 the phase change material 110 comprises applying an alternating or direct electric current (AC or DC) current through heating coils 104 embedded in the baseplate 102. In another aspect, heating 304 the phase change material 110 comprises passing a fluid through the heating coils 104 embedded in the baseplate 102.

For example, heating 204 is controlled by the control circuit. The control circuit provides a signal to provide current through heating coils 104 or to heat the fluid and circulate the heated fluid through the heating coils 104. In one aspect, the control circuit measures the temperature of the phase change material 110 through a temperature sensor disposed on the baseplate. The control circuit determines when the phase change material 110 has reached its melting point. The control circuit determines when to form the phase change material 110 based on the temperature of the phase change material 110. For example, the control circuit determines the phase change material 110 has reached its melting point based on a time period that the heat has been applied for and/or based on a temperature measurement from a temperature sensor embedded in the baseplate 102.

The method 200 further comprises forming 206 the phase change material 110 in a liquid phase into a pre-determined shape. For example, forming 306 the phase change material 110 is graphically shown in FIG. 2 by step 124. The phase change material 110 comprises a magnetic substance 112 dispersed in the phase change material 110. Step 124 graphically depicts applying heat and the magnetic field to form the phase change material 110 into a pre-determined shape.

In one aspect, forming 206 the phase change material 110 in the liquid phase into the pre-determined shape comprises applying a magnetic field to the phase change material 110 while the phase change material 110 is in the liquid phase such that the phase change material 110 reaches the pre-determined shape. The pre-determined shape is an arcuate shape corresponding to the arcuate shape of the magnetic field.

In one aspect, forming 206 occurs after the phase change material 110 is in the liquid phase. The magnetic coil 106 applies the magnetic field to the phase change material by generating the magnetic field from an electromagnet embedded in the baseplate.

In one aspect, forming 206 occurs concurrently with heating 204. The magnetic coil 106 applies the magnetic field by generating the magnetic field from a permanent magnet embedded in the baseplate. In one aspect, the magnetic coil 106 applies the magnetic field to the phase change material by generating the magnetic field from an electromagnet embedded in the baseplate.

For example, forming 206 is controlled by the control circuit. The control circuit provides the signal to begin applying the magnetic field to the phase change material 110. The control circuit is configured to send an alternating current to the magnetic coil 106 to generate the magnetic field. The magnetic field interacts with the magnetic particles 112 within the phase change material 110 to form the shape. In one aspect, after the control circuit determines the phase change material 110 has reached its melting point, the control circuit controls the forming of the phase change material 110. In one aspect, the control circuit applies both the heat and the magnetic field concurrently.

The method further comprises cooling 208 the phase change material 110 until the phase change material 110 reaches a solid phase. For example, cooling 208 the phase change material 110 is graphically shown in FIG. 2 by step 126. In one aspect, cooling 208 of the phase change material 110 comprises stopping the heating of the phase change material 110. Heat is stopped when current no longer is applied to the heating coil 104. In one aspect, heat is stopped when hot fluid is no longer applied to the heating coil 104.

In one aspect, cooling 208 of the phase change material 110 comprises applying coolant through coolant channels (shown in FIG. 5) embedded in the baseplate. In one aspect, cooling the phase change material 110 comprises applying coolant through the heating coil 104 in place of hot fluid.

For example, the control circuit controls the cooling 208 of the phase change material 110. The control circuit is configured to send a signal to stop the application of heat to the phase change material 110. In one aspect, cooling is done without the application of coolant. In one aspect, the control circuit is configured to control the application of the coolant after the phase change material has formed a pre-determined shape. In one aspect, the coolant is configured to flow through the coil 104. The control circuit stops the application of coolant once the control circuit determines the temperature of the phase change material 110 is less than the freezing point of the phase change material 110. In one aspect, the control circuit is coupled to a temperature sensor to determine the temperature of the phase change material 110.

Turning to FIG. 10, in conjunction with FIG. 1, in one aspect the control circuit 802 is to control the pump 808 to pump the fluid 806 through the tube 804 to cool the phase change material. The control circuit 802 is configured to turn on the pump 808 and circulate fluid 806 through the tube 804. The heater 812 is not turned on during cooling.

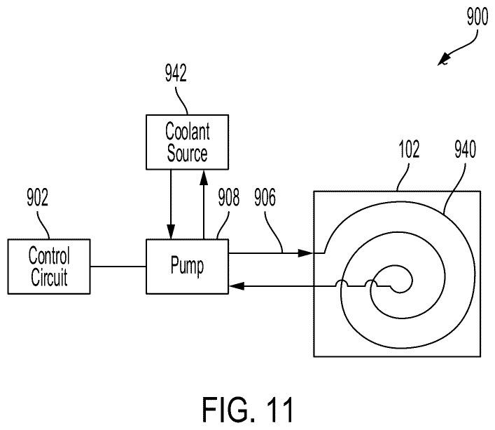

Turning to FIG. 11, in conjunction with FIG. 1, in one aspect, the coil 104 is a tube or coolant channel 940 configured to receive a coolant. Turning briefly to FIG. 11, there is shown a system 900 comprising a control circuit 902 coupled to a pump 908 in fluid communication with a coolant source 942. The pump 908 supplies the coolant 906 to the tube 940. The coolant 906 is received in the tube 940. The heat from the phase change material is transferred from the baseplate 102 to the coolant 906. The coolant removes the heat from the baseplate 102. The control circuit 902 is configured to control the application of coolant 906 to the tube 804. For example, the control circuit 902 is configured to control the pump 908. The control circuit 902 is configured to turn on and off the pump 908. The pump 908 is configured to circulate the coolant 906 from the coolant source 942 through the pump 908 through the tube 940, back through the pump 808, and into the coolant source 942.

In one aspect, where the heating coil 104 is an electrically conductive heating coil (such as the coil 704 one shown in FIG. 9), the baseplate 102 can comprise either no coolant channel to allow for manual cooling or a coolant channel 940 (such as the one in the system 900 shown in FIG. 11).

In one aspect, where the heating coil 104 is a tube (such as the tube 804 shown in FIG. 10), the baseplate 102 can comprise a singular tube or two tubes. In one aspect, where the baseplate 102 comprises a singular tube, the tube can be configured similar to the system 800 in FIG. 10.

In another aspect, where the baseplate 102 comprises a singular tube, the tube can be configured to receive both heated fluid and coolant. For example, the tube is fluidically coupled to both a fluid source and a coolant source. In one aspect, the fluid source and the coolant source are coupled to the same pump. In one aspect, the fluid source and the coolant source are coupled to different pumps.

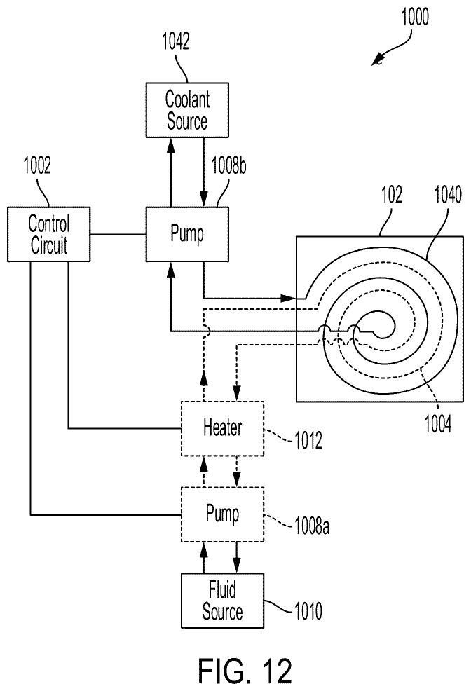

In one aspect, where the baseplate comprises two tubes, the system could be configured as shown in system 1000 of FIG. 12. The system 1000 comprises a heating tube 1004 and a coolant tube 1040. The heating tube 1004 as shown is configured as a tube to receive fluid. The heating tube 1004, heating pump 1008a, heater 1012, heating pump 1008a, and fluid source 1010 are configured to operate in a manner similar to that of the heating system 800 in FIG. 10.

The system 1000 comprises a coolant tube 1040 separate from the heating tube 1004. The coolant tube 1040, coolant pump 1008b, and coolant source 1042 are configured to operate in a manner similar to that of the coolant system 900 in FIG. 11. The control circuit 1002 is configured to control the coolant pump 1008b, the heating pump 1008a, and the heater 1012.

The control circuit 1002 is configured to control the coolant pump 1008b in a similar manner to the method of control of the pump 908 (FIG. 11). The control circuit 1002 is also configured to control the heater 1012 and heating pump 1008a in a similar manner to pump 808 and heater 812 (FIG. 10). In another embodiment, the heating system 700 could replace the heating system of FIG. 12 (the fluid source 1010, heater 1012, and heating pump 1008a).

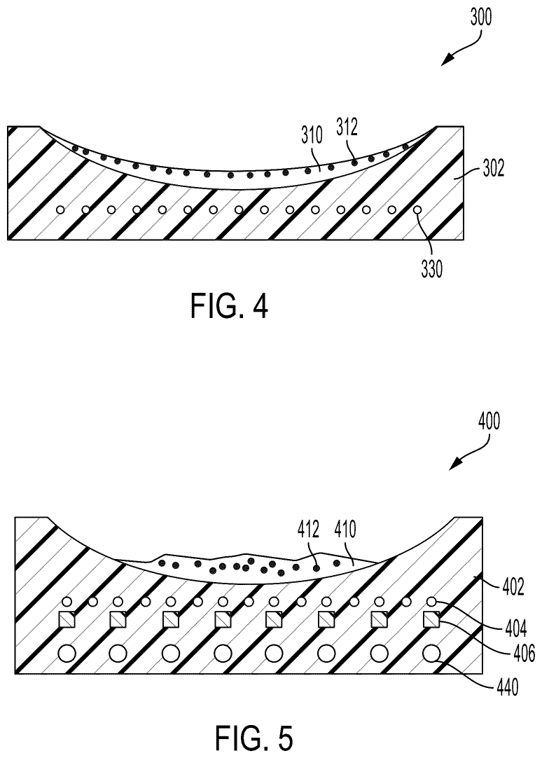

FIG. 4 is a cross-sectional view of a phase change mirror, according to an aspect of this disclosure. The phase change mirror 300 comprises a baseplate 302 and phase change material 310 with a magnetic substance 312 dispersed throughout. The baseplate 302 and phase change material 310 with magnetic substance 312 are similar to the baseplate 102 and phase change material 110 with magnetic substance 112 of FIGS. 1 and 2.

The phase change mirror comprises a coil 330. The coil 330 provides heat and a magnetic field. To provide the magnetic field an AC current is passed through the coil 330. To provide heat, either an AC current or a DC current is passed through the coil 330. The phase change mirror 300 applies heat and a magnetic field through the coil 330 instead of through a heat coil 104 and a magnetic coil 106, but otherwise operates in a similar manner to phase change mirror 100.

FIG. 5 is a cross-sectional view of a phase change mirror 400 with coolant channels 440, according to an aspect of this disclosure. The phase change mirror 400 comprises a baseplate 402, heating coils 404, magnetic coils 406, and phase change material 410 disposed in a cavity of the baseplate 402. The phase change mirror 400 is similar in structure and operation to the phase change mirror 100. In one aspect, the phase change material comprises a magnetic substance 412.

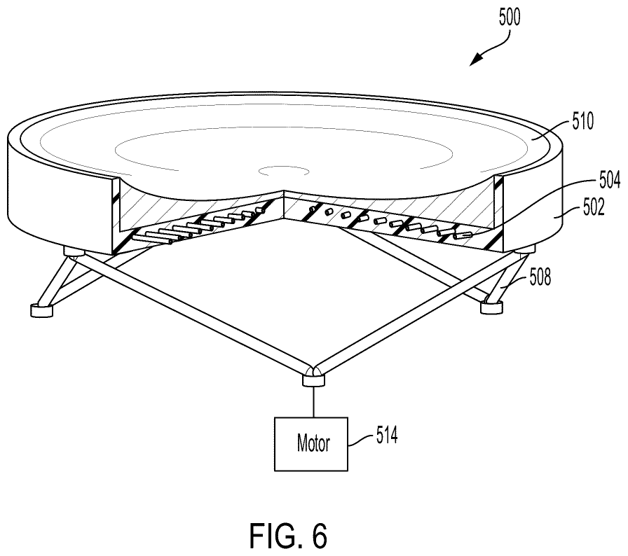

The phase change mirror 400 comprises coolant channels 440 that receive coolant. The coolant is circulated through the coolant channels 440. The heat from the phase change material 410 and baseplate 402 is removed by the coolant flowing through the coolant channels 440. In one aspect, the coolant channels can be added to the phase change mirror 300 of FIG. 4. In one aspect, the coolant channels can be added to the phase change mirror 500 of FIG. 6. In one aspect, the control circuit is configured to control the application and removal of coolant through the coolant channels 440.

The heating coils 404 can either be electrically conductive heating coils (as shown in electrically conductive heating coil 704 in FIG. 9) or a tube for heated fluid (as shown in tube 804 in FIG. 10).

Turning briefly to FIG. 11, in conjunction with FIG. 5, in one aspect, the coolant channels 440 are the coolant channels 940. The coolant channels 440 operate in a similar manner to coolant channels 940 and are controlled by a control circuit similar to control circuit 902.

In one aspect, the method 200 further comprises determining the mirror is damaged. In response to determining the mirror is damaged, the mirror is reformed. Reforming the mirror comprises repeating the steps of FIG. 2: heating the phase change material, forming the phase change material in a liquid phase into a pre-determined shape, and cooling the phase change material until it reaches a solid phase. Reforming the mirror can be done anytime. The control circuit may determine the mirror is damaged based on an analysis of the image created by the mirror. For example, the control circuit may determine the mirror is damaged based on an analysis of the image.

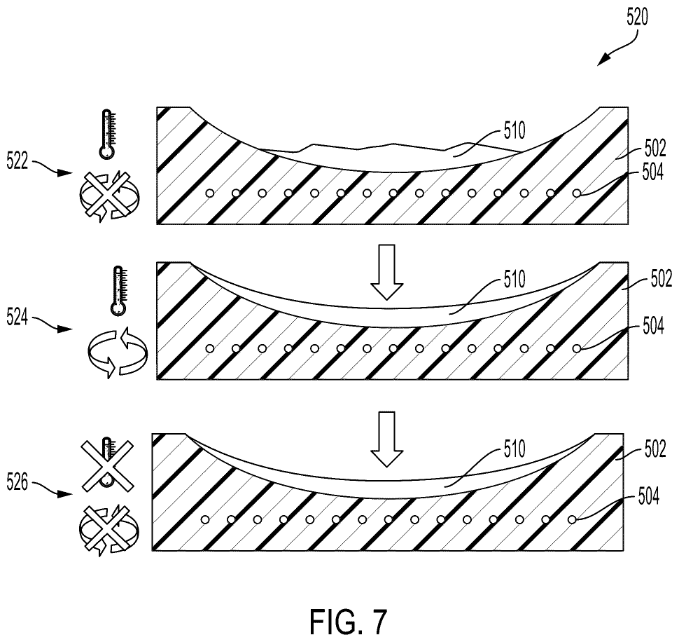

FIG. 6 is a phase change mirror 500 coupled to a motor 514, according to an aspect of the disclosure. The phase change mirror 500 comprises a baseplate 502 structured to house the phase change material 510. The baseplate 502 defines a cavity and the phase change material 510 is located in the cavity of the baseplate 102. In one aspect, the bottom portion of the baseplate 502 defines a flat surface of the cavity (shown in FIG. 6). In one aspect, the bottom portion of the baseplate 502 defines an arcuate surface of the cavity such that the baseplate 502 defines a concave surface (shown in FIG. 7).

The bottom portion of the baseplate 502 houses coils or tubes used for heating. The coils or tubes are disposed within the baseplate 502. In one aspect, the baseplate 502 comprises a heating coil 504. The baseplate 502 is thermally conductive to transfer heat from the heating coil 504 to the phase change material 510.

The phase change material 510 is disposed in the cavity of the baseplate 502. In one aspect, the phase change material 510 is a material with a melting/solidification temperature which exceeds the maximum intended use temperature of the mirror. The use temperature of the mirror is temperature of the environment in which the phase change mirror 500 is to be used. The phase change material 510 changes between the solid and liquid phase based on the application of heat from the heating coils 504. Examples of materials are tin based solder alloys, Bismuth based fusible alloys, pure metals such as Mercury or Gallium or polymers such as paraffin. In one aspect, the phase change material 110 has ferromagnetic particles of Iron, Cobalt, or Nickel.

In one aspect, the heating coil 504 is a conductive coil. The heating coil 504 is disposed within the bottom portion of the baseplate 502. The heating coil 504 is a conductive coil that receives an alternating or direct electric current (AC or DC) current. The current heats the heating coil 504 which transfers heat to the baseplate 102. The baseplate 502, being thermally conductive, transfers the heat to the phase change material 510.

In one aspect, the heating coil 504 is a tube configured to receive a fluid. The fluid is heated by a heater before entering the heating coil 504. The heat from the fluid is transferred through the thermally conductive baseplate 502 to the phase change material 510.

The phase change mirror 500 further comprises a structure 508 for rotating the phase change mirror 500. In one aspect, the structure 508 is a hexapod disposed underneath the baseplate 502 to tip and tilt the baseplate 502. The phase change mirror 500 comprises a rotary motor 514 disposed underneath the baseplate 502 to rotate the baseplate 502 about a central axis.

The phase change mirror 500 may comprise any of the systems of FIGS. 9-12 in which different configurations of heating and cooling systems are shown. For example, the phase change mirror may comprise a baseplate 502 with a singular coil (heating coil 704, tube 804, or coolant channel 940 as shown in FIGS. 9-11) or two coils (heating tube 1004 and coolant tube 1040 as shown in FIG. 12). The baseplate 502 may comprise an electric heating system (FIG. 9) or a fluid heating system (FIG. 10). The baseplate 502 may comprise a coolant system as in FIG. 11. In another aspect, the baseplate may comprise both a coolant system and a heating system (one example of which is shown in FIG. 12). The phase change mirror 500 may comprise any combination of electrically conductive heating coils and tubes as discussed in FIG. 1.

In one aspect, the phase change mirror 500 is made by a process comprising locating a phase change material 510 in the baseplate 502, heating the phase change material 510, forming the phase change material 510 in a liquid phase into a pre-determined shape, and cooling the phase change material 510 until it reaches a solid phase.

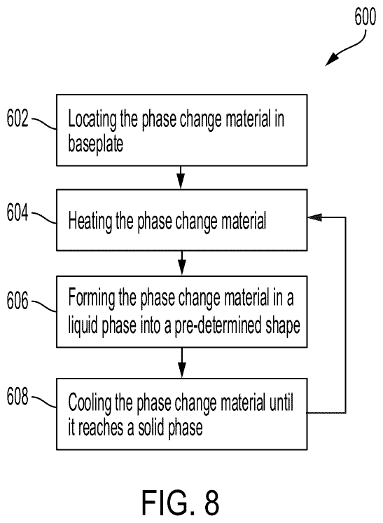

FIG. 7 is a graphical depiction 520 of the method of forming the phase change mirror 500 of FIG. 6, according to an aspect of this disclosure. FIG. 8 is a method 600 of forming the phase change mirror 500 of FIG. 6. FIGS. 7 and 8 are described in conjunction. The method 600 of forming the phase change mirror 500 comprises locating 602 the phase change material 510 in the baseplate 502. The method 600 of operating the phase change mirror is controlled by a control circuit (not shown) coupled to the phase change mirror 500.

The method further comprises heating 604 the phase change material. The phase change material 510 is heated above the melting point of the phase change material 510. By heating the phase change material 510 above the melting point, the phase change material 510 becomes a liquid. The liquid form of the phase change material 510 allows for the reformation of the phase change material 510 into a shape.

For example, heating 604 the phase change material 510 is shown in FIG. 7 by step 522. The phase change material 510 is shown before the phase change mirror 500 is rotated. Heat is being applied through the heating coils 504.

In one aspect, heating 604 the phase change material 510 comprises applying an alternating or direct electric current (AC or DC) current through heating coils 504 embedded in the baseplate 502. In another aspect, heating 604 the phase change material 510 comprises passing a fluid through the heating coils 504 embedded in the baseplate 502.

For example, heating 604 is controlled by the control circuit. The control circuit provides a signal to provide current through heating coils 504 or to heat the fluid and circulate the heated fluid through the heating coils 504. In one aspect, the control circuit measures the temperature of the phase change material 510 through a temperature sensor disposed on the baseplate. The control circuit determines when the phase change material 510 has reached its melting point. The control circuit determines when to form the phase change material 510 based on the temperature of the phase change material 510.

The method further comprises forming 606 the phase change material 510 in a liquid phase into a pre-determined shape. For example, forming 606 the phase change material 510 is graphically shown in FIG. 7 by step 524. Step 524 graphically depicts applying heat and the rotation by the motor 514 to form the phase change material 510 into a pre-determined shape.

In one aspect, forming 606 the phase change material 510 in the liquid phase into the pre-determined shape comprises rotating the baseplate 502 about a central axis while the phase change material 510 is in the liquid phase such that the phase change material 510 reaches the pre-determined shape. In one aspect, the pre-determined shape is an arcuate shape caused by centrifugal force created by rotating the baseplate 502.

For example, forming is controlled by the control circuit. The control circuit is configured to send the signal to begin rotating the baseplate 502. The control circuit is configured to determine the phase change material 510 has reached its melting point, and begin rotating the baseplate 502 after the phase change material 510 has reached its melting point. In one aspect, the control circuit applies both the heat and the rotation concurrently.

The method further comprises cooling 608 the phase change material 510 until the phase change material 510 reaches a solid phase. For example, cooling 608 the phase change material 510 is graphically shown in FIG. 7 by step 526. In one aspect, cooling 608 of the phase change material 510 comprises stopping the heating of the phase change material 510. In one aspect, heat is stopped when current no longer is applied to the heating coil 504. In one aspect, heat is stopped when hot fluid is no longer applied to the heating coil 504.

In one aspect, cooling of the phase change material 510 comprises applying coolant through coolant channels (shown in FIG. 5) embedded in the baseplate. In one aspect, cooling the phase change material 510 comprises applying coolant through the heating coil 504 in place of hot fluid.

For example, the control circuit controls the cooling 608 of the phase change material. The control circuit is configured to send a signal to stop the application of heat to the phase change material 510. In one aspect, the control circuit is to control the application of the coolant after the phase change material has formed a pre-determined shape. The control circuit stops the application of coolant after the control circuit determines the temperature of the phase change material 510 is less than the freezing point of the phase change material 510. In one aspect, the control circuit is coupled to a temperature sensor to determine the temperature of the phase change material 510.

Having thus described several aspects and embodiments of the technology of this application, it is to be appreciated that various alterations, modifications, and improvements will readily occur to those of ordinary skill in the art. Such alterations, modifications, and improvements are intended to be within the spirit and scope of the technology described in the application. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, and/or methods described herein, if such features, systems, articles, materials, and/or methods are not mutually inconsistent, is included within the scope of the present disclosure.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

The phrase “and/or,” as used herein in the specification and in the claims, should be understood to mean “either or both” of the elements so conjoined, i.e., elements that are conjunctively present in some cases and disjunctively present in other cases.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. The transitional phrases “consisting of” and “consisting essentially of” shall be closed or semi-closed transitional phrases, respectively.

Where a range or list of values is provided, each intervening value between the upper and lower limits of that range or list of values is individually contemplated and is encompassed within the disclosure as if each value were specifically enumerated herein. In addition, smaller ranges between and including the upper and lower limits of a given range are contemplated and encompassed within the disclosure. The listing of exemplary values or ranges is not a disclaimer of other values or ranges between and including the upper and lower limits of a given range.

The use of headings and sections in the application is not meant to limit the disclosure; each section can apply to any aspect, embodiment, or feature of the disclosure. Only those claims which use the words “means for” are intended to be interpreted under 35 USC 112(f). Absent a recital of “means for” in the claims, such claims should not be construed under 35 USC 112. Limitations from the specification are not intended to be read into any claims, unless such limitations are expressly included in the claims.

Embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, embodiments may take the form of a computer program product embodied in one or more computer readable medium(s) having computer readable program code embodied thereon.

What is claimed is:

1. A method of forming a mirror, the method comprising:
locating a phase change material in a baseplate;
heating the phase change material;
forming the phase change material in a liquid phase into a pre-determined shape; and
cooling the phase change material until it reaches a solid phase.

2. The method of claim 1, wherein the heating of the phase change material comprises applying an alternating or direct electric current (AC or DC) current through heating coils embedded in the baseplate.

3. The method of claim 1, wherein the heating of the phase change material comprises passing a fluid through heating tubes embedded in the baseplate.

4. The method of claim 1, wherein the heating of the phase change material comprises heating the phase change material above a melting point of the phase change material.

5. The method of claim 4, further comprising dispersing a magnetic substance in the phase change material.

6. The method of claim 5, wherein forming the phase change material in the liquid phase into the pre-determined shape comprises applying a magnetic field to the phase change material while the phase change material is in the liquid phase such that the phase change material reaches the pre-determined shape, wherein the pre-determined shape is an arcuate shape corresponding to the arcuate shape of the magnetic field.

7. The method of claim 6, wherein applying the magnetic field comprises generating the magnetic field from a permanent magnet embedded in the baseplate.

8. The method of claim 6, wherein applying the magnetic field comprises generating the magnetic field from an electromagnet embedded in the baseplate.

9. The method of claim 5, wherein dispersing the magnetic substance in the phase change material comprises homogenously disbursing the magnetic substance.

10. The method of claim 1, wherein the cooling of the phase change material comprises stopping the heating of the phase change material.

11. The method of claim 1, wherein the cooling of the phase change material comprises applying coolant through coolant channels embedded in the baseplate.

12. The method of claim 4, wherein forming the phase change material in the liquid phase into the pre-determined shape comprises rotating the baseplate about a central axis while the phase change material is in the liquid phase such that the phase change material reaches the pre-determined shape, wherein the pre-determined shape is an arcuate shape caused by centrifugal force created by rotating the baseplate.

13. The method of claim 1, further comprising:
determining the mirror is damaged; and
in response to determining the mirror is damaged, further comprising:
heating the phase change material;
forming the phase change material in a liquid phase into a pre-determined shape; and
cooling the phase change material until it reaches a solid phase.

14. A phase change mirror made by a process comprising:
locating a phase change material in a baseplate;
heating the phase change material;
forming the phase change material in a liquid phase into a pre-determined shape; and
cooling the phase change material until it reaches a solid phase.

15. The phase change mirror of claim 14, wherein the phase change material is material with a melting temperature which exceeds a maximum intended use temperature of the phase change mirror.

16. The phase change mirror of claim 14, wherein the baseplate is thermally conductive.

17. The phase change mirror of claim 14, wherein coolant channels are disposed within the baseplate.

18. The phase change mirror of claim 14, further comprising a hexapod disposed underneath the baseplate to tip and tilt the baseplate or a rotary motor disposed underneath the baseplate to rotate the baseplate about a central axis.

19. The phase change mirror of claim 14, further comprising a magnet disposed in baseplate.

20. The phase change mirror of claim 14, wherein heating channels are disposed within the baseplate.
